(19) United States
(12) Patent Application Publication
(10) Pub. No.: US 2015/0235228 A1
(43) Pub. Date: Aug. 20, 2015

(54) METHOD, DEVICE AND SYSTEM FOR ON-LINE PAYMENT INFORMATION TRANSMISSION

(71) Applicant: Tencent Technology (Shenzhen) Co., Ltd., Shenzhen (CN)

(72) Inventor: Tiehua Liu, Shenzhen (CN)

(21) Appl. No.: 14/615,076

(22) Filed: Feb. 5, 2015

Related U.S. Application Data
(63) Continuation of application No. PCT/CN2014/079137, filed on Jun. 4, 2014.

(30) Foreign Application Priority Data
Nov. 15, 2013 (CN) 2013105740544

(51) Int. Cl. G06Q 20/42; H04L 29/08

(52) U.S. Cl. CPC G06Q 20/42; H04L 67/10; H04L 67/306

(57) ABSTRACT

A method, device and system for on-line payment information transmission are disclosed. The method includes: upon detecting a payment order which pertains to a payment account: sending by a server via a port number which contains verification information, a prompt message to a communication account tied to the payment account, the verification information to prompt a reply from a user to send back a payment confirmation message; receiving by a terminal, the payment confirmation message input by the user, wherein the terminal corresponds to the communication account, and sending by the terminal via the communication account to the port number, the payment confirmation message; receiving by the server via the port number, the payment confirmation message; extracting by the server, the verification information from the port number according to the received payment confirmation message, and processing the payment order according to the verification information.

### CROSS-REFERENCE TO RELATED APPLICATIONS

The application is a continuation of PCT Application No. PCT/CN2014/079137, filed on Jun. 4, 2014, which claims priority to Chinese Patent Application No. 2013105740544, filed on Nov. 15, 2013, which are incorporated by reference in their entireties.

### FIELD OF THE TECHNOLOGY

The disclosure belongs to the field of Internet technology; to a method, device and system for on-line payment information transmission.

### BACKGROUND

With rapid development of Internet technologies, online payment using credit card, debit card or direct bank checking or saving account transfer have become increasingly popular. Today's process of online payment may take the following steps: a server generates a short message containing a verification code, and then sends the short message to a user's terminal. After the user's terminal receives the short message, the user may enter the verification code into the terminal, and then return a short message containing the verification code back to the server. Upon receiving the short message returned by the user's terminal, the server may extract the verification code from the short message, and complete the online payment. The above process, however, requires the user to enter the verification code into the terminal which the verification code usually may include a string of numbers and/or letters. The verification code input process itself is quite cumbersome and prone to errors due to a long string of numbers and letters. After a few entries with typographical errors, the user may be locked out from the transaction. Therefore, the efficiency of such on-line payment may be very low.

### SUMMARY

The embodiments of the present disclosure provide a method, device, and system for on-line payment information transmission, which may improve the efficiency of payment.

In an aspect of the present disclosure, there is provided a method for on-line information transmission, which includes: upon detecting a payment order which pertains to a payment account: sending by a server via a port number which contains verification information, a prompt message to a communication account which is tied to the payment account, wherein the verification information is used to prompt a reply from a user to send back a payment confirmation message; receiving by a terminal, the payment confirmation message which is input by the user in response to the received prompt message, wherein the terminal corresponds to the communication account, and sending by the terminal via the communication account to the port number, the payment confirmation message; receiving by the server via the port number, the payment confirmation message; extracting by the server, the verification information from the port number according to the received payment confirmation message, and processing the payment order according to the verification information.

In a second aspect of the present disclosure, there is provided a method for on-line payment information transmission, which includes: upon detecting a payment order which pertains to a payment account: sending via a port number of a server, the port number contains verification information, a prompt message to a communication account which ties to the payment account, wherein the verification information is used to prompt a reply from a user to send back a payment confirmation message; the server receiving via the port number from a terminal, the payment confirmation message input by the user which corresponds to the communication account; and extracting the verification information from the server's port number according to the received payment confirmation message, and processing the payment order according to the verification information.

In a third aspect of the present disclosure, there provide a method for information transmission, comprising:

When a payment account generates a payment order, receiving a prompt message sent by the server via a port number containing verification information, wherein the prompt message is used to prompt a reply with a payment confirmation message;

Receiving the payment confirmation message input by the user in response to the prompt message, and sending the payment confirmation message to the port number via a communication account tied with the payment account, so that the server receives the payment confirmation message via the port number, then extracts the verification information from the port number according to the payment confirmation message, and finally processes the payment order according to the verification information.

In the fourth respect, the embodiments of the present disclosure provide a system for information transmission, comprising a server and a terminal, wherein:

When a payment order of a payment account is detected, the server is used to send a prompt message to a communication account tied with the payment account via a port number containing verification information, wherein the verification information is used to prompt a reply with a payment confirmation message;

The terminal is associated with the communication account and the terminal is used to receive the prompt message as well as the payment confirmation message input by the user in response to the prompt message, and send the payment confirmation message to the port number via the communication account;

The server is further used to receive the payment confirmation message via the port number, extract the verification information from the port number according to the payment confirmation message, and then process the payment order according to the verification information.

In the fifth respect, the embodiments of the present disclosure provide a device for information transmission comprising a transmitting unit, a receiving unit, and a processing unit, wherein:

When a payment order of a payment account is detected, the transmitting unit is used to send a prompt message to a communication account tied with the payment account via the port number containing verification information, wherein the verification information is used to prompt returning with a payment confirmation message;

Via the port number, the receiving unit receives the payment confirmation message sent by a terminal associated with the communication account to the port number via the communication account;

The processing unit extracts the verification information from the port number according to the payment confirmation message, and then processes the payment order according to the verification information.

In the sixth respect, the embodiments of the present disclosure provide a device for information transmission, comprising a receiving unit, and a transmitting unit, wherein:

When the payment account generates a payment order, the receiving unit receives the prompt message that the server sends via the port number containing the verification information, wherein the prompt message is used to prompt returning with a payment confirmation message;

The transmitting unit receives the payment confirmation message input by the user in response to the prompt message, and sends the payment confirmation message to the port number via a communication account tied with the payment account, so that the server receives the payment confirmation message via the port number, then extracts the verification information from the port number according to the payment confirmation message, and finally processes the payment order according to the verification information.

The above technical solution comprises: When the server detects a payment order of a payment account, the server sends a prompt message to a communication account tied with the payment account via the port number containing verification information, the terminal associated with the communication account receives the payment confirmation message input by the user in response to the prompt message, and then sends the payment confirmation message to the port number via the communication account; the server receives the payment confirmation message via the port number, extracts the verification information from the port number according to the payment confirmation message, and finally processes the payment order according to the verification information. In this way, the server may extract the verification information from the port number. In other words, the user does not need to add the verification information to the payment confirmation message returned to the server, so payment efficiency is improved.

### BRIEF DESCRIPTION OF THE DRAWINGS

The accompanying drawings are included to provide a further understanding of the claims and disclosure, are incorporated in, and constitute a part of this specification. The detailed description and illustrated embodiments described serve to explain the principles defined by the claims.

FIG. 1 shows an interactive flow diagram of an exemplary method for on-line payment information transmission, according to an embodiment of the present disclosure.

FIG. 2 shows an interactive flow diagram of another method for on-line payment information transmission, according to an embodiment of the present disclosure.

FIG. 3 shows a flowchart of another method for on-line payment information transmission, according to an embodiment of the present disclosure.

FIG. 4 shows a flowchart of another method for on-line payment information transmission, according to an embodiment of the present disclosure.

FIGS. 5 and 6A, 6B illustrate examples of the on-line payment method using a terminal (such as a mobile device), according to embodiments of the present disclosure.

FIG. 7 illustrates a system diagram of an on-line payment information transmission, according to an embodiment of the present disclosure.

FIG. 8 shows an exemplary structure diagram of a device for on-line payment information transmission, according to an embodiment of the present disclosure.

FIG. 9 shows an exemplary structure diagram of another device for on-line payment information transmission, according to an embodiment of the present disclosure.

FIG. 10 shows an exemplary structure diagram of another device for on-line payment information transmission, according to an embodiment of the present disclosure.

FIG. 11 shows an exemplary structure diagram of another device for on-line payment information transmission, according to an embodiment of the present disclosure.

### DETAILED DESCRIPTION OF THE EMBODIMENTS

The various embodiments of the present disclosure are further described in details in combination with attached drawings and embodiments below. It should be understood that the specific embodiments described here are used only to explain the present disclosure, and are not used to limit the present disclosure. In addition, for the sake of keeping description brief and concise, the newly added features, or features that are different from those previously described in each new embodiment will be described in details. Similar features may be referenced back to the prior descriptions in a prior numbered drawing or referenced ahead to a higher numbered drawing.

In order to clarify the object, technical scheme and advantages of the present disclosure more specifically, the present disclosure is illustrated in further details with the accompanied drawings and embodiments. It should be understood that the embodiments described herein are merely examples to illustrate the present disclosure, but not to limit the present disclosure.

In the embodiments of the present disclosure, a communication account may include but not limited to an instant messaging account, Email account, and a mobile number that may uniquely identify a communication user. In addition, a terminal may be any network-capable device, including but not limited to a laptop computer, mobile phone, electronic reader, remote controller, PC, notebook computer, vehicle-mounted device, network TV set, and a wearable device. The terminal associated with the communication account may refer to a login terminal of the communication account, that is, the terminal whereby the communication account logs into a communication system.

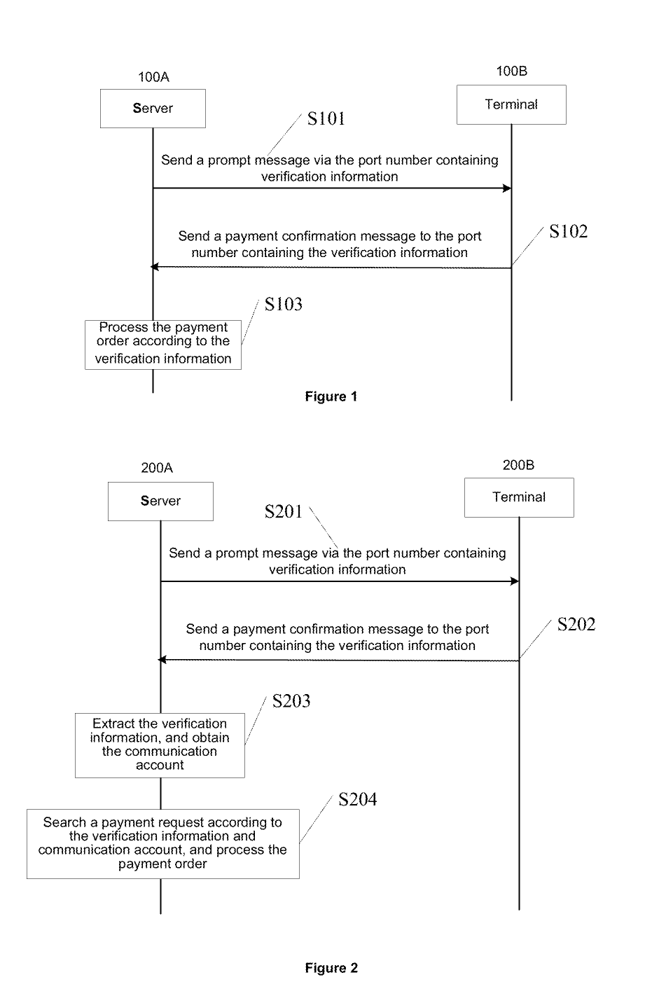

FIG. 1 shows an interactive flow diagram of an exemplary method for on-line payment information transmission, according to an embodiment of the present disclosure. The method may include at least the following:

S101: Upon the server (100A) detecting a payment order which pertains to a payment account, the server sends a prompt message to a communication account which is tied to the payment account via a port number which contains verification information, wherein the verification information is used to prompt a reply from a user to back a payment confirmation message from a terminal (100B).

Without limiting, optionally, the payment order may be an order whereby the payment account may make payments to a receiving account, and the payment order may include information such as payment account, receiving account, and payment amount.

Without limiting, optionally, the port number may be a port number whereby the server (100A) may send information, and the server may send information through multiple port numbers. The port number may specifically include an original port number and the verification information, wherein the original port number may be a port number that the server may purchase from a network operator. For example, if the port number is “123456789” and the verification information is “XXXXXX”, then the port number in Step S101 may be “123456789XXXXXX”, that is, the server may send a prompt message to the communication account via the port number “123456789XXXXXX”.

Without limiting, optionally, the prompt message may be a text message. For example, the prompt message may be “Please reply with a payment confirmation message”, “Please press any key to reply with a payment confirmation message”, or “Please press the Y key to reply with a payment confirmation message”.

S102: The terminal (100B) may be associated with the communication account and receives the prompt message as well as the payment confirmation message input by the user in response to the prompt message, and the terminal may send the payment confirmation message to the server's port number via the communication account.

Without limiting, optionally, the terminal (100B) may display the prompt message on the terminal upon receiving the prompt message, and the user may then enter a payment confirmation message into the terminal in response to the received prompt message after reading the prompt message. For example, the payment confirmation message may be any text or a query request sent to the server (100A), for example, a request to query the related information of the payment order including the receiving account and payment amount. After receiving the payment confirmation message input by the user, the terminal may send the payment confirmation message to the port number via the communication account.

Without limiting, optionally, the terminal in Step S102 may receive the prompt message via the communication account.

S103: The server (100A) may receive the payment confirmation message via the port number, extracts the verification information from the port number according to the payment confirmation message, and then processes the payment order according to the verification information;

Without limiting, optionally, after receiving the payment confirmation message, the server may extract the verification information from the port number according to the payment confirmation message. For example, a destination address or the port number mentioned above from the data packets which contains the payment confirmation message may then extract the verification information from the port number such as the verification information from the port number that receives the payment confirmation message. After extracting the verification information, the server may process the payment order according to the verification information.

In addition, the server may specifically verify the verification information, and process the payment order if the verification information passes the verification by, for example, comparing the verification information obtained in Step S103 with the verification information obtained in Step S101, and determining whether the verification is successful. if so, the two information may agree with each other. In addition, the server may query the payment order according to the verification information by, for example, tying to the payment order with the verification information in Step S101, and querying the payment order according to the verification information in Step S103;

Without limiting, optionally, the payment account may specifically be an account registered with the server. The server (100A) may specifically be a transaction platform server or a bank server.

FIG. 2 shows an interactive flow diagram of another method for on-line payment information transmission, according to an embodiment of the present disclosure. The method may include at least the following:

S201: Upon the server (200A) detecting a payment order which pertains to a payment account, the server sends a prompt message to a communication account which is tied to the payment account via a port number which contains verification information, wherein the verification information is used to prompt a reply from a user to back a payment confirmation message from a terminal (200B).

Without limiting, optionally, the server (200A) may specifically detect that a payment account may generate a payment order, such as a payment order be sent to the server by the payment account, and may request the payment account to pay a certain amount to a receiving account. For example, a payment order may be sent to the server by a receiving account for a request to collect a certain amount from a payment account.

Without limiting, optionally, Step S201 may take place upon detecting the payment order; the server (200B) may generate the port number according to the verification information which is associated with the payment order and the original port number. The server (200A) may then send the prompt message to the communication account via the generated port number. In addition, the server may also tie the verification information and communication account with the payment order, and stores the tied information locally.

S202: The terminal (200B) may associate with the communication account, receive the prompt message as well as the payment confirmation message input by the user in response to the received prompt message, and the terminal may send the payment confirmation message to the port number via the communication account.

Without limiting, optionally, the payment confirmation message may be a text message, a voice message, or an image message. In addition, the user may enter the payment confirmation message by a touch on a screen, by clicking physical keys, or by voice command.

S103: The server (200A) may receive the payment confirmation message via the port number, extracts the verification information from the port number according to the payment confirmation message, and then obtains the communication account from the payment confirmation message.

Without limiting, optionally, the process of information transmission typically involves a source address and a destination address, such that the source address of the payment confirmation message may be the communication account, and the destination address of the payment confirmation message may be the port number. Therefore, the port number and communication account may be obtained from the payment confirmation message in Step S203.

S204: The server (200A) may search the payment order according to the verification information and the communication account, and then processes the payment order, wherein the payment order may be pre-tied with the verification information and the communication account.

Without limiting, optionally, upon detecting the payment order in step S201, the server may generate the verification information mentioned above, then tie the verification information with the communication account and the payment order, and then store the tied verification information, the communication account, and the payment order. When the server (200A) obtains the verification information and the communication account according to the payment confirmation message sent by the terminal (200B) in Step S203, the server may query the payment order according to the obtained verification information and communication account in step S204; because the verification information may be tied to the communication account and the payment order in step S201, and the payment order may be queried in step S204 according to the verification information and the communication account obtained in Step S203.

Without limiting, optionally, the payment order may specifically be processed by transferring the payment amount from the payment account to the receiving account, wherein the payment order may contain the payment amount and the receiving account.

Without limiting, optionally, the verification information may be used to prompt a reply with a payment confirmation message containing specific information. Specifically, the receiving by the terminal of the payment confirmation message input by the user in response to the prompt message may include: the terminal receives the payment confirmation message containing the specific information input by the user in response to the received prompt message.

Specifically, the extracting by the server of the verification information from the port number according to the received payment confirmation message may include: the server obtains the specific information contained in the payment confirmation message, verifies the specific information, and extracts the verification information from the port number according to the payment confirmation message, if the specific information passes the verification;

In other words, the payment confirmation message may contain the specific information. In addition, the server (200A) may obtain the port number, the communication account, and the specific information upon receiving the payment confirmation message from the terminal (200B) because the payment confirmation message is sent to the port number via the communication account. The server may verify the obtained specific information, and then obtain the port number if the specific information passes the verification, and extract the verification information and the communication account from the port number.

Without limiting, optionally, the specific information mentioned above may include at least one of the following: specific text and human body features of the user, wherein, the specific text may be numbers and/or letters and the human body features may be biometric information such as fingerprint information, pupil information, or face information of the user, to name a few.

In an embodiment, the method may support dual verification. In other words, the verification information may be obtained only after the specific information passes the verification, and then the payment order may be processed according to the verification information. In this embodiment, the verification information may be contained in the port number rather than being input by the user. In this regard, the payment security may be improved by verifying the specific information, thus preventing payment made by mistake during payment operation.

For example, the server may generate a prompt message to prompt a reply with a payment confirmation message to be sent back by a user containing specific information of the user only when the payment amount in the payment order is large (for example, exceeding a predetermined amount). In this way, payment security may be improved when the payment amount is large.

In addition, the server may generate a prompt message to prompt a reply with a payment confirmation message that may contain other information when the payment amount is small (for example, smaller than a predetermined amount). In this way, the user may only need to respond with a payment confirmation message, for example, a payment confirmation message that does not need to define the information it contains and may be sent by the user clicking any key. In this way, it may be easier for the user to operate when the payment amount is small.

Without limiting, optionally, receiving by the terminal the payment confirmation message input by the user in response to the prompt message may include: the terminal receiving the payment confirmation message containing a query request input by the user in response to the received prompt message.

Subsequent to Step S202, the method may further include: in response to the query request, the server may send a response message to the communication account. The terminal may receive the response message sent by the server, wherein, the query request may specifically be a request to query the related information of the payment order, such as receiving account, payment amount, or involving goods.

After receiving the payment confirmation message, the server may obtain the query request and generate the response message in response to the query request. For example, when the query request may be a request to query the payment amount, the server may generate a response message containing the payment amount, and send the response message to the communication account. Then, the terminal may receive the response message. Using this mode, the disclosure allows confirming the payment and query information by returning a response message, thus reducing power consumption of the terminal and saving network resources.

Without limiting, optionally, the receiving by the terminal a payment confirmation message input by the user in response to the prompt message may include: the terminal receiving a voice payment confirmation message input by the user in response to the prompt message. Using this mode, the user may reply to the payment confirmation message by voice. In addition, the terminal may also play the prompt message by voice after receiving the prompt message, and then the user may enter the payment confirmation message by voice after hearing the received prompt message played by the terminal. In this way, the user may confirm the payment without touching or operating the terminal.

For example, when the terminal receives the prompt message, the user may be engaged in other activities (for example, washing clothes or playing games) which may not be convenient for the user to operate the terminal. Using this mode, the method allows confirming the payment without requiring the user to cease from the on-going activities. The user's experience is thus improved by enabling to carry out multiple tasks while making a payment operation.

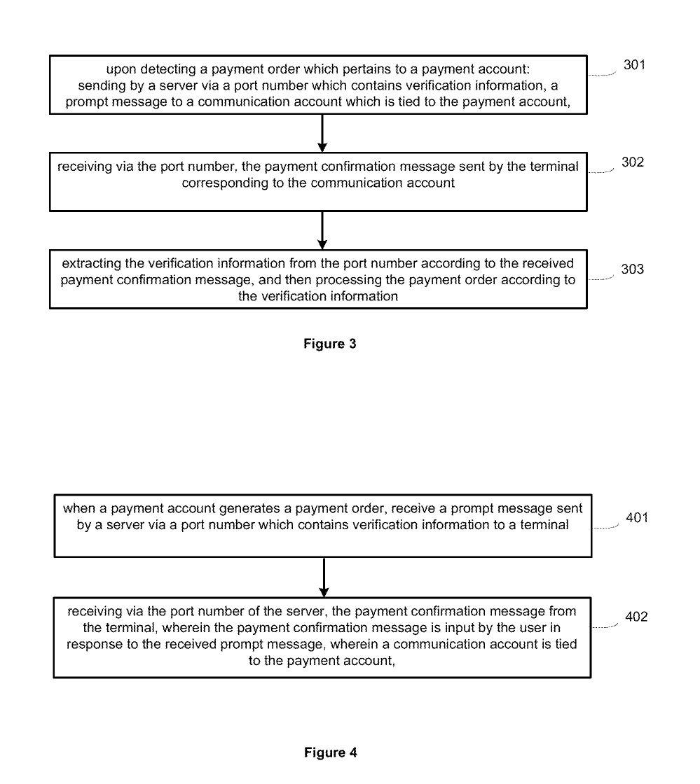

FIG. 3 shows a flowchart of another method for on-line payment information transmission, according to an embodiment of the present disclosure. The flow chart may include at least the followings:

S301: upon detecting a payment order which pertains to a payment account: sending by a server via a port number which contains verification information, a prompt message to a communication account which is tied to the payment account, wherein the verification information is used to prompt a reply from a user to send back a payment confirmation message.

Without limiting, optionally, the payment order may be a payment order whereby a payment account may make payments to a receiving account. The payment order may contain such information as payment account, receiving account, and payment amount, etc. . . . .

Without limiting, optionally, the port number may be a port number whereby the server may send messages, and the server may send messages through multiple port numbers. Specifically, the port number may include an original port number and the verification information, wherein the original port number may specifically be a port number that the server purchased from a network operator. For example, if the port number is “123456789” and the above verification information is “XXXXXX”, then the port number in Step S301 may be “123456789XXXXXX”. That is, the server may send a prompt message to the communication account via the port number “123456789XXXXXX”.

Without limiting, optionally, the prompt message may specifically be a text message. For example, the prompt message may be “Please return a payment confirmation message”, “Please press any key to return a payment confirmation message”, or “Please press the Y key to return a payment confirmation message”, which is not restricted by this embodiment.

S302: receiving via the port number, the payment confirmation message sent by the terminal corresponding to the communication account.

S303: extracting the verification information from the port number according to the received payment confirmation message, and then processing the payment order according to the verification information.

Without limiting, optionally, after the payment confirmation message is received in step S302, the server may extract the verification information from the port number according to the payment confirmation message in step S303, such as extracting the destination address (which is the port number) from the data packets containing the payment confirmation message, and then extracting the verification information from the port number. The server may extract the verification information from the port number that receives the payment confirmation message; afterwards process the payment order according to the verification information;

In addition, Step S303 may verify the verification information and then process the payment order if the verification information passes the verification by, for example, comparing the verification information obtained in step S303 with the verification information obtained in step S301, and determining whether the verification is successful or not. If so, the information may agree with each other. In addition, the server may query the payment order according to the verification information, by such as tying the payment order with the verification information in step S301, and querying the payment order according to the verification information in step S303;

Without limiting, optionally, the processing of the payment order according to the verification information specifically may include: obtaining the communication account from the payment confirmation message, searching the payment order according to the verification information and the communication account, and processing the payment order, wherein the payment order is pre-tied with the verification information and the communication account.

Without limiting, optionally, the verification information may specifically be used to prompt a reply with a payment confirmation message containing specific information, and the payment confirmation message received in step S302 may specifically be the payment confirmation message containing specific information. In step S303, the specific information may be verified, the verification information may be extracted if the specific information passes the verification, and then the payment order is processed according to the verification information.

Without limiting, optionally, the specific information may include at least one of the following: specific text and human body features of the user. Wherein, the specific text may include numbers and/or letters and the human body features may be biometric information, such as fingerprint information, pupil information, or face information, etc. Using this mode, the disclosure may support dual verification to improve the security of payment.

Without limiting, optionally, the payment confirmation message received in step S302 may also be a payment confirmation message containing a query request, and subsequent to Step S302, the method may further include: in response to the query request, the server may send a response message to the communication account. Wherein, the query request may specifically be a request to query related information of the payment order, and using this mode, the disclosure may allow the terminal to confirm the payment and query related information, thus reducing power consumption of the terminal and saving network resources.

Without limiting, optionally, the method may specifically be applied to a server, for example, a transaction platform server of bank server.

The technical solution comprises: sending a prompt message to a communication account tied with the payment account via a port number containing verification information when detecting a payment order of a payment account; via the port number, receiving the payment confirmation message sent by the terminal associated with the communication account to the port number via the communication account; extracting the verification information from the port number according to the payment confirmation message, and then processing the payment order according to the verification information.

FIG. 4 shows a flowchart of another method for on-line payment information transmission, according to an embodiment of the present disclosure. The method may include the following:

S401: When a payment account generates a payment order, receive a prompt message sent from the server via a port number containing verification information, wherein the prompt message is used to prompt a reply from a user to send back a payment confirmation message.

Without limiting, optionally, the payment order of the payment account may be generated by either the terminal provided in this method or another terminal, in step S401, the prompt message received via the communication account may be tied with the payment account.

S402: Receiving the payment confirmation message input by the user in response to the received prompt message, and sending the payment confirmation message to the port number via the communication account which is tied with the payment account, so that the server which receives the payment confirmation message via the port number, extracts the verification information from the port number according to the payment confirmation message, and then processes the payment order according to the verification information.

Without limiting, optionally, the verification may specifically be used to prompt a reply with a payment confirmation message containing specific information, and the receiving of the payment confirmation message input by the user in response to the received prompt message may include: receiving the payment confirmation message containing the specific information input by the user in response to the received prompt message.

Without limiting, optionally, the specific information may include at least one of the following: specific text and human body features of the user, wherein, the specific text may be numbers and/or letters and the human body features may be biometric data, such as fingerprint information, pupil information, or face information of the user, etc.

This allows the payment confirmation message containing the specific information to be sent to the server, so that the server extracts the verification information only after the specific information passes the verification, and then it processes the payment order according to the verification information. As a result, the security of payment may be improved by dual verification of payment;

Without limiting, optionally, the receiving of the payment confirmation message input by the user in response to the prompt message may include: receiving the payment confirmation message containing a query request that the user enters in response to the received prompt message; subsequent to Step S402, the method may also include: receiving the response message that the server sends in response to the query request; wherein, the query request may specifically be a request to query the related information of the payment order; after receiving the payment confirmation message, the server may obtain the query request and generate the response message in response to the query request; the mode of carrying out the disclosure may serve to confirm the payment and query related information by returning the response message, thus reducing power consumption of the terminal and saving network resources.

Without limiting, optionally, the receiving of the payment confirmation message input by the user in response to the prompt message may include: receiving a voice payment confirmation message input by the user in response to the prompt message. This mode may allow the user to reply to the payment confirmation message by voice. In addition, the terminal may also play the prompt message by voice after receiving the prompt message, and then the user may enter a voice payment confirmation message after hearing the prompt message played by the terminal. In this way, the user may confirm the payment without touching or operating the terminal, so this mode may allow confirming the payment without requiring the user to stop performing other activities, so user experience is improved.

Without limiting, optionally, the method may be applied to any terminal, such as a network-capable device, including but not limited to a laptop computer, mobile phone, electronic reader, remote controller, PC, notebook computer, vehicle-mounted device, network TV set, and wearable device.

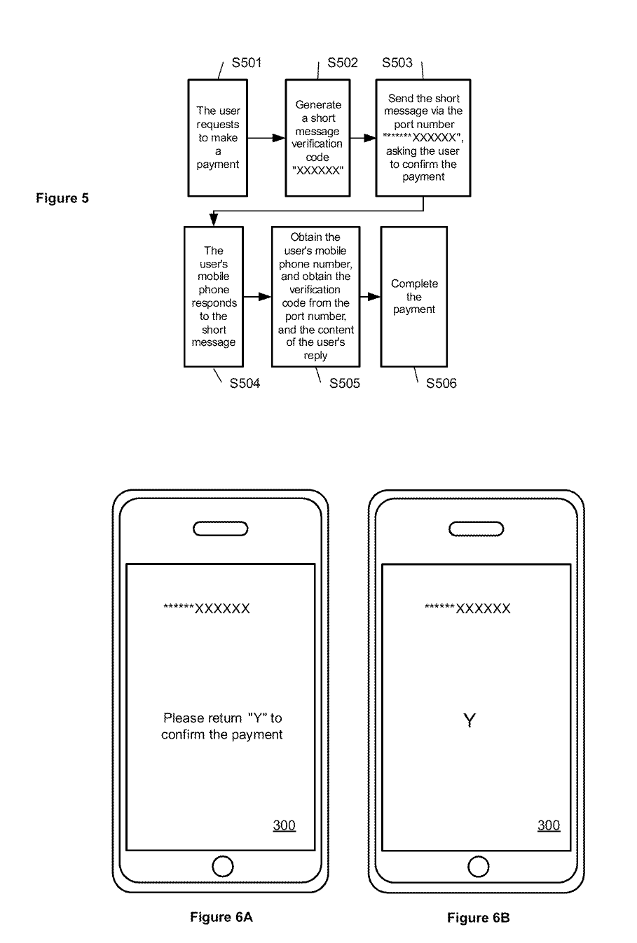

FIGS. 5 and 6A, 6B illustrate several examples of the on-line payment method using a terminal (such as a mobile device), according to embodiments of the present disclosure. The method may include at least the following:

S501: The server obtains the user's request to make a payment.

S502: The server generates a short message with verification code “XXXXXX”.

S503: The server sends the short message to the user's mobile phone number via the port number “******XXXXXX”, so that the user may confirm making the payment.

S504: The terminal (300) (see FIG. 6A), such as a user's mobile phone receives the above short message, and responds to the short message via the mobile phone number. For example, as shown in FIG. 6A, the terminal (300) may display the text: “Please reply with Y to confirm the payment”, of the short message sent by the server, as shown in FIG. 6A; the terminal (300) then receives the short message whose text is “Y” (as input by the user), and then returns the message to the port number, as shown in FIG. 6B.

S505: The server obtains the mobile phone number, extracts the verification code from the port number, and obtains the text of the short message returned by the user.

S505: The server completes the payment.

The following section describes an embodiment of the device provided by the present disclosure, which is used to carry out the methods implemented by Embodiments 1 to 4 (i.e., FIGS. 1-4) of the method provided by the present disclosure. For the convenience of description, the following section only describes the parts related to the embodiments of the present disclosure.

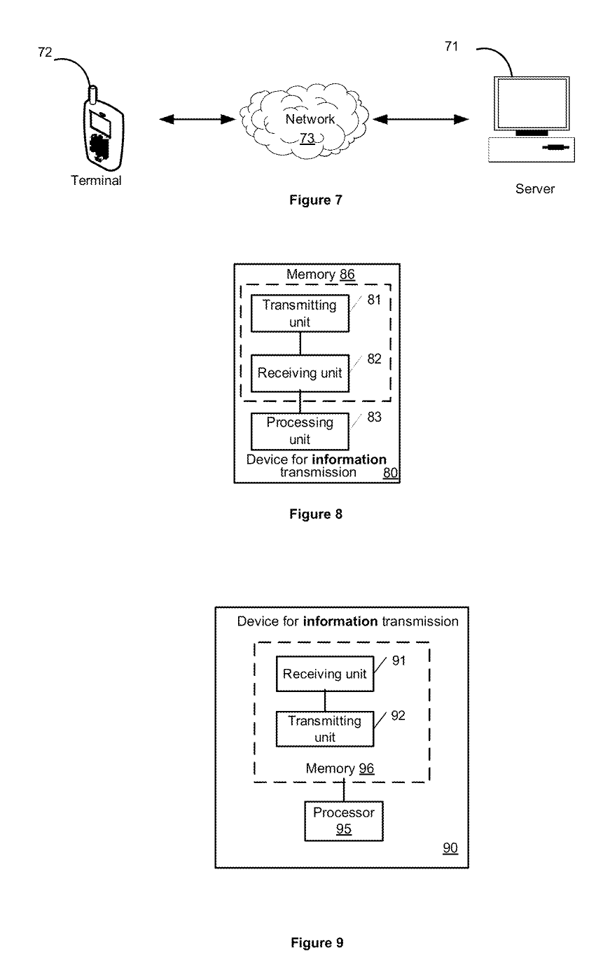

FIG. 7 illustrates a system diagram of an on-line payment information transmission, according to an embodiment of the present disclosure. The system may include at least a server (71) and a terminal (72), wherein: upon detecting a payment order of a payment account, the server sends via a port number which contains verification information, a prompt message to a communication account which is tied to the payment account, wherein the verification information is used to prompt a reply from a user to send back a payment confirmation message.

The terminal (72) may be associated with the communication account. In response to receiving the prompt message from the server (71), the terminal may also receive the payment confirmation message input by the user, wherein the payment confirmation message may be sent via the communication account to the port number.

The server (71) may receive the payment confirmation message via the port number, extracts the verification information from the port number according to the payment confirmation message, and then processes the payment order according to the verification information.

Upon detecting a payment order of a payment account, the server (71) may send a prompt message to a communication account which is tied to the payment account via a port number containing verification information, wherein the verification information is used to prompt a reply from a user to back a payment confirmation message.

Without limiting, optionally, the payment order may specifically be an order whereby a payment account may make a payment to a receiving account. The payment order may contain such information as payment account, receiving account, and payment amount.

Without limiting, optionally, the port number may be a port number whereby the server (71) sends messages, and the server (71) may send messages through multiple port numbers. The port number may include an original port number and the verification information, wherein the original port number may specifically be a port number that the server (71) may purchase from a network operator. For example, if the port number is “123456789” and the above verification information is “XXXXXX”, then the port number may be “123456789XXXXXX”, that is, the server (71) sends a prompt message to the communication account via the port number “123456789XXXXXX”.

Without limiting, optionally, the prompt message may be a text. For example, the prompt message may be “Please return a payment confirmation message”, “Please press any key to return a payment confirmation message”, or “Please press the Y key to return a payment confirmation message”, which is not restricted by this embodiment.

The terminal (72) may be associated with the communication account and receive the prompt message as well as the payment confirmation message input by the user in response to the prompt message, and the terminal may send the payment confirmation message to the port number via the communication account.

Without limiting, optionally, the terminal (72) may display the prompt message upon receiving the prompt message, and the user may enter the payment confirmation message into a terminal in response to the received prompt message after reading the prompt message; wherein the content of the payment confirmation message is not limited. For example, the payment confirmation message may be any text or a query request sent to the server (71), for example, requesting to query related information of the payment order such as receiving account and payment amount. After receiving the payment confirmation message input by the user, the terminal (72) may send the payment confirmation message to the port number via the communication account. Without limiting, optionally, the terminal (72) may specifically receive the prompt message via the communication account.

The server (71) may receive the payment confirmation message via the port number, extracts the verification information from the port number according to the payment confirmation message, and then processes the payment order according to the verification information.

Without limiting, optionally, after receiving the payment confirmation message, the server (71) may extract the verification information from the port number according to the payment confirmation message. For example, the server may extract the destination address (which is the port number) from the data packets containing the payment confirmation message, and then extracts the verification information from the port number; for example, the verification information from the port number that receives the payment confirmation message. After extracting the verification information, the server may process the payment order according to the verification information. In addition, the server (71) may specifically verify the verification information, and process the payment order after the verification information passes the verification. Further, the server (71) may also query the payment order according to the verification information.

Optionally, the payment account may specifically be an account registered with the server (71). The server (71) may specifically be a transaction platform server (71) or a bank server (71), which is not restricted in this embodiment.

Optionally, the server (71) is further used to obtain the communication account from the payment confirmation message, search the payment order according to the verification information and the communication account, and process the payment order, wherein the payment order may be pre-tied with the verification information and the communication account. Specifically, when generating the verification information, the server (71) may tie the verification information with the communication account and the payment order, and then store the tied verification information, the communication account, and the payment order. After the server (71) obtains the verification information and communication account according to the payment confirmation message sent by the terminal (72), the server (71) may query the payment order according to the obtained verification information and communication account in step S204.

Without limiting, optionally, the verification information may specifically be used to prompt a reply with a payment confirmation message containing specific information. The terminal (72) may receive the payment confirmation message containing the specific information input by the user in response to the received prompt message;

The server (71) is further used to obtain specific information contained in the payment confirmation message, verify the specific information, and extract the verification information from the port number according to the payment confirmation message if the specific information passes the verification.

Without limiting, optionally, the specific information may include at least one of the following: specific text and human body features of the user, wherein, the specific text may be numbers and/or letters and the human body features may be biometric information of the user, such as fingerprint information, pupil information, or face information, etc.

This mode of the disclosure may support dual verification. That is, the verification information may be obtained only after the specific information passes the verification, and then the payment order is processed according to the verification information. In this embodiment, the verification information may be contained in the port number rather than input by the user, so payment security may be improved by verifying the specific information, thus preventing accidental payment made by the mistake of the user.

Without limiting, optionally, the terminal (72) may further be used to receive the payment confirmation message containing a query request input by the user in response to the prompt message. In response to the query request, the server (71) may be further used to send a response message to the communication account;

The terminal (72) may be further used to receive the response message sent by the terminal. Wherein, the query request may specifically be a request to query related information of the payment order, such as receiving account, payment amount, and involved goods. After receiving the payment confirmation message, the server (71) may obtain the query request and generate the response message in response to the query request. For example, when the query request is a request to query the payment amount, the server (71) may generate a response message containing the payment amount, and send the response message to the communication account. This allows the terminal (72) to receive the response message. Using this mode of payment operation allows confirming the payment and querying related information by returning a response message, thus reducing power consumption of the terminal (72) and saving network resources;

Without limiting, optionally, the terminal (72) may be further used to receive a voice payment confirmation message input by the user in response to the prompt message. This mode of the disclosure allows the user to return a payment confirmation message by voice. In addition, the terminal (72) may also play the prompt message by voice after receiving the prompt message, and then the user may enter the payment confirmation message by voice after hearing the prompt message played by the terminal (72). In this way, the user may confirm the payment without touching or operating the terminal (72). For example, when the terminal (72) receives the prompt message, the user may be doing other things (for example, washing clothes or playing games) so it is inconvenient for the user to operate the terminal (72). In this case, with this mode, the disclosure allows confirming the payment without requiring the user to stop doing other activities, so user experience is improved.

FIG. 8 shows an exemplary structure diagram of a device (80) for on-line payment information transmission, according to an embodiment of the present disclosure. The device may include at least a processor (83) operating in conjunction with at least a memory (86) which stores instruction codes operable as plurality of units, wherein the plurality of units includes: a transmitting unit (81) and a receiving unit (82), wherein: upon detecting a payment order which pertains to a payment account, the transmitting unit (81) may send via a port number which contains verification information, a prompt message to a communication account which is tied to the payment account, wherein the verification information is used to prompt a reply from a user to send back a payment confirmation message.

The receiving unit (82) may receive via the port number, the payment confirmation message. The processing unit (83) may extract the verification information from the port number according to the received payment confirmation message, and processes the payment order according to the verification information.

Without limiting, optionally, the payment order may specifically be an order whereby a payment account makes payments to a receiving account, and may contain such information as payment account, receiving account, and payment amount.

Without limiting, optionally, the port number may be a port number whereby to send information, and the device (80) may send information through multiple port numbers. The port number may specifically comprise an original port number and the verification information, wherein the original port number may specifically be a port number that the device purchases from a network operator. For example, if the port number is “123456789” and the above verification information is “XXXXXX”, then the port number in Step S301 may be “123456789XXXXXX”, that is, the transmitting unit (81) sends a prompt message to the communication account via the port number “123456789XXXXXX”.

Without limiting, optionally, the prompt message may specifically be a text. For example, the prompt message may be “Please return a payment confirmation message”, “Please press any key to return a payment confirmation message”, or “Please press the Y key to return a payment confirmation message”, which is not restricted by this embodiment.

Via the port number, the receiving unit (82) receives the payment confirmation message sent by the terminal associated with the communication account to the port number via the communication account.

The processing unit (83) extracts the verification information from the port number according to the payment confirmation message, and then processes the payment order according to the verification information.

Optionally, after the receiving unit (82) receives the payment confirmation message, the processing unit (83) may extract the verification information from the port number according to the payment confirmation message, for example, the destination address (which is the port number) from the data packets containing the payment confirmation message, and then extract the verification information from the port number, or the verification information from the port number that receives the payment confirmation message. After extracting the verification information, the processing unit (83) may process the payment order according to the verification information.

In addition, the processing unit (83) may specifically verify the verification information, and process the payment order if the verification information passes the verification by, for example, comparing the verification information obtained by the processing unit (83) with the verification information in the transmitting unit (81), and determining that the verification is successful if the two information agrees with each other. In addition, the server may query the payment order according to the verification information. For example, the transmitting unit (81) ties the payment order with the verification information, and the processing unit (83) queries the payment order according to the verification information.

Without limiting, optionally, the processing unit (83) may also be used to extract the verification information from the port number according to the payment confirmation message, obtain the communication account from the payment confirmation message, look up the payment order according to the verification information and the communication account, and then process the payment order, wherein the payment order is pre-tied with the verification information and the communication account.

Optionally, the verification information may specifically be used to prompt a reply with a payment confirmation message containing specific information, and the payment confirmation message received by the receiving unit (82) may specifically be the payment confirmation message containing specific information. The processing unit (83) may verify the specific information, extract the verification information if the specific information passes the verification, and then process the payment order according to the verification information.

Without limiting, optionally, the specific information may include at least one of the following: Specific text and human body features of the user, wherein, the specific text may be numbers and/or letters and the human body features may be user's biometric information, such as fingerprint information, pupil information, or face features information, etc.

This mode of the disclosure may support dual verification to improve the security of payment;

Without limiting, optionally, the payment confirmation message received by the receiving unit (82) may also be a payment confirmation message containing a query request, and the device may also comprise:

A response unit, which may send a response message to the communication account in response to the query request, wherein, the query request may specifically be a request to query related information of the payment order, and the mode of the disclosure may allow the terminal to confirm the payment and query related information, thus reducing power consumption of the terminal and saving network resources.

Without limiting, optionally, the device (80) may specifically be applied to a server, for example, a transaction platform server of bank server.

FIG. 9 shows an exemplary structure diagram of another device (90) for on-line payment information transmission, according to an embodiment of the present disclosure. The device (90) may include at least a processor (95) operating in conjunction with at least a memory (96) which stores instruction codes operable as plurality of units, wherein the plurality of units includes: a transmitting unit (92) and a receiving unit (91).

When a payment account generates a payment order, the receiving unit (91) receives a prompt message sent by a server via the port number containing verification information, wherein the prompt message is used to prompt a reply with a payment confirmation message.

Without limiting, optionally, a payment order of the payment account may be generated by either the device (90) or another terminal. The receiving unit (91) may specifically receive the prompt message via a communication account tied with the payment account. The transmitting unit (92) may receive the payment confirmation message input by the user in response to the prompt message, and sends the payment confirmation message to the port number via a communication account tied with the payment account, so that the server receives the payment confirmation message via the port number, then extracts the verification information from the port number according to the payment confirmation message, and then processes the payment order according to the verification information.

Without limiting, optionally, the verification may specifically be used to prompt a reply with a payment confirmation message containing specific information, and the receiving of the payment confirmation message input by the user in response to the prompt message specifically includes: receiving the payment confirmation message containing the specific information input by the user in response to the prompt message.

Without limiting, optionally, the specific information may include at least one of the following: specific text and human body features of the user, wherein, the specific text may be numbers and/or letters and the human body features may be biometric information of the user, such as fingerprint information, pupil information, or face information, etc. . . . .

Without limiting, optionally, the receiving unit may also be used to receive a payment confirmation message containing a query request input by the user in response to the prompt message. The receiving unit (91) may also be used to receive the response message sent by the server in response to the query request. Wherein, the query request may specifically be a request to query the related information of the payment order. After receiving the payment confirmation message, the server may obtain the query request and generate the response message in response to the query request. This mode of the disclosure allows confirming the payment and query information by returning a response message, thus reducing power consumption of the terminal and saving network resources.

Without limiting, optionally, the receiving unit (91) may also be used to receive a voice payment confirmation message input by the user in response to the prompt message. This mode of the disclosure allows the user to return the payment confirmation message by voice. In addition, the terminal may also play the prompt message by voice after receiving the prompt message, and then the user may input the payment confirmation message by voice after hearing the prompt message played by the terminal. In this way, the user may confirm the payment without touching or operating the terminal so this mode of the disclosure allows confirming a payment without requiring the user to stop doing other things, so user experience is improved.

Without limiting, optionally, the device may specifically be applied to any network-capable device, including but not limited to a laptop computer, mobile phone, electronic reader, remote controller, PC, notebook computer, vehicle-mounted device, network TV set, and wearable device.

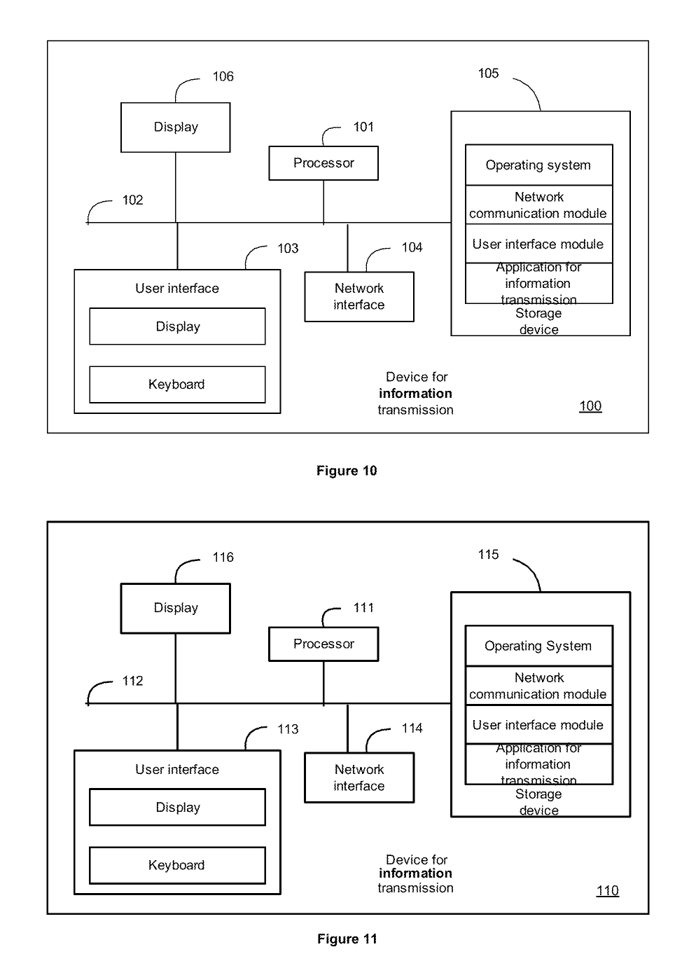

FIG. 10 shows an exemplary structure diagram of another device (100) for on-line payment information transmission, according to an embodiment of the present disclosure. The device (100) may include: at least one processor (101), for example, a CPU, at least one network interface (104), a user interface (103), memory (105), and at least one communication bus (102), wherein, the communication bus (102) may be used for connecting these components.

The user interface (103) may include a display and a keyboard, and the optional user interface (103) may also be a standard wired interface or wireless interface. Optionally, the network interface (104) may be a standard wireless interface or wireless interface (for example, WiFi interface), the memory (105) may be a high-speed RAM memory or a non-volatile memory (for example, at least one disk memory); an optionally, the memory (105) may also be at least one storage device located away from the processor (1001). As shown FIG. 11, the memory (105) as a computer storage medium may comprise an operating system, a network communication module, user interface modules, and applications for interface transmission.

The network interface (104) may mainly be used to connect the terminal for data communication, and the processor (101) may be used to invoke the secure payment application stored in the memory (105) and perform the following operations:

Upon detecting a payment order of a payment account, sending a prompt message to the communication account tied with the payment account via the network interface (104), which contains the verification information, wherein the verification information may be used to prompt a reply with a payment confirmation message;

Via the network interface (104), using the port number to receive the payment confirmation message sent from the terminal associated with the communication account to the port number via the communication account;

Extracting the verification information from the port number according to the payment confirmation message, and then processing the payment order according to the verification information.

Without limiting, optionally, the processor (101) processes the payment order according to the verification information, including: obtaining the communication account from the payment confirmation message, searching the payment order according to the verification information and the communication account, and processing the payment order, wherein the payment order is tied to the verification information and the communication account in advance;

Without limiting, optionally, the verification information may specifically be used to prompt a reply with a payment confirmation message containing specific information, and the payment confirmation message received by the processor (101) may specifically be the payment confirmation message containing specific information. The processor (101) may verify the specific information, extract the verification information if the specific information passes the verification, and then process the payment order according to the verification information.

Without limiting, optionally, the specific information may include at least one of the following: Specific text and human body features of the user. Wherein, the specific text may be numbers and/or letters and the human body features may be fingerprint information, pupil information, or face information, etc. . . . . The mode of the disclosure may support dual verification to improve the security of payment.

Without limiting, optionally, the processor (101) may receive a payment confirmation message containing a query request, and use the port number, via the network interface (104), to receive the payment confirmation message sent from the terminal associated with the communication account to the port number via the communication account; and

In response to the query request, send a response message to the communication account via the network interface (104). Wherein, the query request may specifically be a request to query related information of the payment order, and this mode of the disclosure allows the terminal to confirm the payment and query information by returning a message, thus reducing power consumption of the terminal and saving network resources.

Without limiting, optionally, the device may specifically be applied to a server, for example, a transaction platform server of bank server.

FIG. 11 shows an exemplary structure diagram of another device (110) for on-line payment information transmission, according to an embodiment of the present disclosure. The device (110) may include at least one processor (111), for example, a CPU, at least one network interface (114), a user interface (113), a memory (115), and at least one communication bus (112), wherein the communication bus (112) is used for connecting these components, the user interface (113) may include a display and a keyboard, and the optional user interface (113) may also be a standard wired interface or wireless interface.

Without limiting, optionally, the network interface (114) may be a standard wireless interface or wireless interface (for example, a WiFi interface), and the memory (115) may be a high-speed RAM memory or a non-volatile memory, for example, at least one disk memory. Optionally, the memory (115) may also be at least one storage device located away from the processor (1101). As shown FIG. 11, the memory (115) as a computer storage medium may comprise an operating system, a network communication module, user interface modules, and application programs for interface transmission.

In the device (110), the network interface (114) may be used to connect the server for data communication, and the processor (111) may be used to invoke the secure payment application stored in the memory (115), and perform the following operations:

When a payment account generates a payment order, receiving, via the network interface (114), a prompt message sent from the server via a port number containing verification information, wherein the prompt message is used to prompt a reply with a payment confirmation message;

The user interface (113) may receive a payment confirmation message input by the user in response to the prompt message, and sending, via the network interface (114), the payment confirmation message to the port number via a communication account tied with the payment account, so that the server receives the payment confirmation message via the port number, extracts the verification information from the port number according to the payment confirmation message, and then processes the payment order according to the verification information.

Without limiting, optionally, the verification may be used to prompt a reply with a payment confirmation message containing specific information, and the processor (111) receives, via the user interface (113), the payment confirmation message input by the user in response to the prompt message may include: via the user interface (113), receiving the payment confirmation message containing the specific information input by the user in response to the prompt message.

Without limiting, optionally, the specific information may include at least one of the following: Specific text and human body features of the user, wherein, the specific text may be numbers and/or letters and the human body features may be biometric information of the user such as fingerprint information, pupil information, or face information, etc. . . . .

Without limiting, optionally, the operation of the processor (111) for receiving, via the user interface (113), the payment confirmation message input by the user in response to the prompt message may include: via the user interface (113), receiving a payment confirmation message containing a query request input by the user in response to the prompt message; via the network interface (114), the processor (111) sending the payment confirmation message to the port number by using the communication account tied with the payment account, and: via the network interface (114), receiving a response message sent by the server in response to the query request.

Wherein, the query request may specifically be a request to query related information of the payment order. After receiving the payment confirmation message, the server may obtain the query request and generate the response message in response to the query request. Using this mode of the disclosure may allow confirming the payment and query information by returning a response message, thus reducing power consumption of the terminal and saving network resources.

Without limiting, optionally, the receiving of a payment confirmation message input by the user in response to the prompt message may include: receiving a voice payment confirmation message input by the user in response to the prompt message;

Using this mode of the disclosure may allow the user to return the payment confirmation message by voice. In addition, the terminal may also play the prompt message by voice after receiving the prompt message, and then the user may input the payment confirmation message by voice after hearing the prompt message played by the terminal. In this way, the user may confirm the payment without touching or operating the terminal so this mode of the disclosure may confirm the payment without requiring the user to stop doing other activities, so user experience is improved.

Without limiting, optionally, the device may be applied to any network-capable device, including but not limited to a laptop computer, mobile phone, electronic reader, remote controller, PC, notebook computer, vehicle-mounted device, network TV set, and wearable device.

The above technical solution in various embodiments include: the server may extract the verification information from the port number, that is, the user does not need to add the verification information to the payment confirmation message returned to the server, thereby improving payment efficiency.

It should be understood by those with ordinary skill in the art that all or some of the steps of the foregoing embodiments may be implemented by hardware, or software program codes stored on a non-transitory computer-readable storage medium with computer-executable commands stored within. For example, the disclosure may be implemented as an algorithm as codes stored in a program module or a system with multi-program-modules. The computer-readable storage medium may be, for example, nonvolatile memory such as compact disc, hard drive. ROM or flash memory.

The foregoing represents only some preferred embodiments of the present disclosure and their disclosure may not be construed to limit the present disclosure in any way. Those of ordinary skill in the art will recognize that equivalent embodiments may be created via slight alterations and modifications using the technical content disclosed above without departing from the scope of the technical solution of the present disclosure, and such summary alterations, equivalent has changed and modifications of the foregoing embodiments are to be viewed as being within the scope of the technical solution of the present disclosure.

What is claimed is:

1. A method for on-line payment information transmission, comprising:
upon detecting a payment order which pertains to a payment account:
sending by a server via a port number which contains verification information, a prompt message to a communication account which is tied to the payment account, wherein the verification information is used to prompt a reply from a user to send back a payment confirmation message;
receiving by a terminal, the payment confirmation message which is input by the user in response to the received prompt message, wherein the terminal corresponds to the communication account, and
sending by the terminal via the communication account to the port number, the payment confirmation message;
receiving by the server via the port number, the payment confirmation message;
extracting by the server, the verification information from the port number according to the received payment confirmation message, and processing the payment order according to the verification information.

2. The method according to claim 1, wherein the processing of the payment order by the server according to the verification information, comprising the server performing:
extracting the communication account from the received payment confirmation message,
searching for a payment order according to the verification information and the communication account, and
processing the payment order, wherein the payment order is pre-tied to the verification information and the communication account.

3. The method according to claim 1, wherein:
the verification information is used to prompt the reply from the user to send back the payment confirmation message which contains specific information;
the terminal in response to the received prompt message, receiving the payment confirmation message input by the user, wherein the payment confirmation message contains the specific information:
the extracting by the server, the verification information from the port number according to the payment confirmation message, comprising the server performing:
obtaining the specific information contained in the payment confirmation message,
verifying the specific information, and
if the specific information passes the verification, extracting the verification information from the port number, according to the payment confirmation message.

4. The method according to claim 3, wherein the specific information includes at least one of the following:
specific written text and human body features of the user.

5. The method according to claim 1, wherein the receiving of the payment confirmation message input by the user in response to the prompt message received by the terminal, comprising:
the terminal receiving the payment confirmation message containing a query request input by the user in response to the prompt message; wherein:
after the terminal sending the payment confirmation message to the port number, the server in response to the query request, sending a response message to the communication account, and
the terminal receiving the response message sent by the server.

6. The method according to claim 1, wherein in response to the received prompt message, the payment confirmation message input by the user comprises a voice payment confirmation message.

7. A method for on-line payment information transmission, comprising:
upon detecting a payment order which pertains to a payment account:
sending via a port number of a server, the port number contains verification information, a prompt message to a communication account which ties to the payment account, wherein the verification information is used to prompt a reply from a user to send back a payment confirmation message;
the server receiving via the port number from a terminal, the payment confirmation message input by the user which corresponds to the communication account; and
extracting the verification information from the server's port number according to the received payment confirmation message, and processing the payment order according to the verification information.

8. The method according to claim 7, wherein the server processing the payment order according to the verification information, comprising:
obtaining the communication account from the payment confirmation message, searching for a payment order according to the verification information and the communication account, and
processing the payment order, wherein the payment order is pre-tied to the verification information and the communication account.

9. A method for on-line payment information transmission, comprising:
a server performing:
when a payment account generates a payment order, sending a prompt message via a port number which contains verification information to a terminal, wherein the prompt message is used to prompt a reply from a user to send back a payment confirmation message through the terminal;
receiving via the port number of the server, the payment confirmation message from the terminal, wherein the payment confirmation message is input by the user in response to the received prompt message, wherein a communication account is tied to the payment account,
extracting the verification information from the port number according to the payment confirmation message, and processing the payment order according to the verification information.

10. A system for on-line payment information transmission, comprising at least a server and a terminal, wherein:
upon detecting a payment order of a payment account, the server sends via a port number which contains verification information, a prompt message to a communication account which is tied to the payment account, wherein the verification information is used to prompt a reply from a user to send back a payment confirmation message;
the terminal which is associated with the communication account, in response to receiving the prompt message from the server, also receives the payment confirmation message input by the user, wherein the payment confirmation message is sent via the communication account to the port number;
the server receives the payment confirmation message via the port number, extracts the verification information from the port number according to the payment confirmation message, and then processes the payment order according to the verification information.

11. The system according to claim 10, wherein the server extracts the communication account from the received payment confirmation message, search a payment order according to the verification information and the communication account, and processes the payment order, wherein the payment order is pre-tied to the verification information and the communication account.

12. The system according to claim 10, wherein the verification information is used to prompt the reply from the user to send back the payment confirmation message which contains specific information;
the terminal in response to the received prompt message, receives the payment confirmation message input by the user, wherein the payment confirmation message contains the specific information;
if the specific information passes the verification, the server obtains the specific information contained in the payment confirmation message, verifies the specific information, and extracts the verification information from the port number according to the payment confirmation message.

13. The system according to claim 12, wherein the specific information includes at least one of the following: specific written text and human body features of the user.

14. The system according to claim 10, wherein the terminal in response to the received prompt message, receives the payment confirmation message containing a query request input by the user;
the server sends a response message to the communication account in response to the query request;
the terminal receives the response message sent by the server.

15. The system according to claim 10, wherein the terminal in response to the received prompt message, receives a voice payment confirmation message input by the user.

16. A device for on-line payment information transmission, comprises at least a processor operating in conjunction with at least a memory which stores instruction codes operable as plurality of units, wherein the plurality of units comprise: a transmitting unit and a receiving unit, wherein:
upon detecting a payment order which pertains to a payment account:
the transmitting unit sends via a port number which contains verification information, a prompt message to a communication account which is tied to the payment account, wherein the verification information is used to prompt a reply from a user to send back a payment confirmation message;
the receiving unit receives via the port number, the payment confirmation message;
the processing unit extracts the verification information from the port number according to the received payment confirmation message, and processes the payment order according to the verification information.

17. The device according to claim 16, wherein the processing unit extracts the verification information from the port number according to the payment confirmation message, obtains the communication account from the received payment confirmation message, searches the payment order according to the verification information and the communication account, and processes the payment order, wherein the payment order is pre-tied to the verification information and the communication account.
